(19) United States
(12) Patent Application Publication
(10) Pub. No.: US 2014/0219070 A1
(43) Pub. Date: Aug. 7, 2014

(54) Optical Pickup and Optical Disk Unit

(71) Applicant: Funai Electric Co., Ltd., Osaka (JP)

(72) Inventor: Taiki MORI, Daito-shi (JP)

(73) Assignee: Funai Electric Co., Ltd., Osaka (JP)

(21) Appl. No.: 14/168,076

(22) Filed: Jan. 30, 2014

(30) Foreign Application Priority Data
Feb. 6, 2013 (JP) 2013-021570

(51) Int. Cl. G11B 7/1395

(52) U.S. Cl. CPC G11B 7/1395
USPC 369/47.1; 369/112.01; 369/112.04; 369/112.03

(57) ABSTRACT

An optical pickup includes a light source, a light splitting element generating signal light and position adjustment light by splitting return light from an optical disk and dispersing the return light in different directions, and a light receiving portion having a signal light receiving portion and an adjustment light receiving portion. The light splitting element is configured such that the position thereof is adjusted on the basis of the position adjustment light received by the adjustment light receiving portion of the light receiving portion.

### BACKGROUND OF THE INVENTION

1. Field of the Invention

The present invention relates to an optical pickup and an optical disk unit, and more particularly, it relates to an optical pickup and an optical disk unit each including a light splitting element splitting return light from an optical disk.

2. Description of the Background Art

An optical pickup including a light splitting element is known in general, as disclosed in Japanese Patent Laying-Open No. 2001-312829 for example.

An optical pickup described in the aforementioned Japanese Patent Laving-Open. No. 2001-312829 includes a hologram element (light splitting element) and a light detector having a plurality of light receiving elements. The hologram element splits return light from an optical disk into 0th order light, +1st order light, and −1st order light, diffracts the three in different directions, and allows the light receiving elements to individually receive the split return light as signal light. A tracking error signal or a data signal is generated from an output signal of each of the light receiving elements receiving the signal light, and the tracking error signal or the data signal is employed for signal processing or control when the optical disk is reproduced.

The positional displacement of a light condensing spot significantly influences signal output, and hence it is necessary to position the hologram element and the light detector of the optical pickup with high accuracy. When the hologram element is mounted on the optical pickup, the mounting position is finely adjusted while actually, the return light is received and the output signal is detected. The adjustment of the mounting position of the hologram element is to properly arrange the hologram element in an orthogonal surface direction with respect to the optical axis of the return light and thereafter adjust the rotational position of the hologram element about the optical axis. When the hologram element is rotated about the optical axis, a light condensing spot of the split signal light formed on a light receiving surface of the light detector is rotated in a circumferential direction using the light condensing position of the 0th order light that is the center of the optical axis as the center. The rotational position is properly determined on the basis of an increase or decrease in the output signal of each of the light receiving elements when the hologram element is rotated about the optical axis.

In the optical pickup according to the aforementioned Japanese Patent Laying-Open No. 2001-312829, it is necessary to render the light condensing spot of the signal light condensed on the light receiving surface sufficiently smaller than the size of the light receiving surface of each of the light receiving elements in general. This is necessary in order to reliably perform the signal output even when each part is displaced due to an error in manufacturing, change with time, thermal expansion/contraction, etc. of an overall optical system including the hologram element and the light receiving elements, and the light condensing spots are displaced with respect to the light receiving elements.

In the case where the light condensing spot is small with respect to the light receiving surface as described above, however, a small change in the rotation angle of the hologram element results in a large change in the output signal when the mounting position of the hologram element is adjusted, and the rotational position is adjusted in a narrow region in the vicinity of an optimum rotational position. Thus, it is necessary to find a proper mounting position (rotational position) by changing the rotational position of the hologram element in the vicinity of the proper position many times. In the optical pickup according to the aforementioned Japanese Patent Laying-Open No 2001-312829, therefore, it is difficult to mount the hologram element (light splitting element), and it takes time to mount the hologram element.

### SUMMARY OF THE INVENTION

The present invention has been proposed in order to solve the aforementioned problem, and an object of the present invention is to provide an optical pickup and an optical disk unit each having a light splitting element capable of being easily and promptly mounted.

An optical pickup according to a first aspect of the present invention includes a light source emitting light to an optical disk, a light splitting element generating signal light employed for optical disk signal processing and position adjustment light not employed for the optical disk signal processing by splitting return light from the optical disk and dispersing the return light in different directions, and a light receiving portion having a signal light receiving portion receiving the signal light and an adjustment light receiving portion receiving the position adjustment light, while the light splitting element is configured such that the position thereof is adjusted on the basis of the position adjustment light received by the adjustment light receiving portion of the light receiving portion.

As hereinabove described, the optical pickup according to the first aspect of the present invention is provided with the light splitting element generating the position adjustment light not employed for the optical disk signal processing and the light receiving portion having the adjustment light receiving portion receiving the position adjustment light, and the light splitting element is configured such that the position thereof is adjusted on the basis of the position adjustment light received by the adjustment light receiving portion of the light receiving portion, whereby the rotational position of the light splitting element can be adjusted, using the position adjustment light for position adjustment not employed for the signal processing (signal reproduction, tracking control, etc.) when the disk is reproduced and the adjustment light receiving portion. In this case, as to the position adjustment light not employed for the signal processing and the adjustment light receiving portion, it is not necessary to consider the positional displacement of a light condensing spot resulting from change with time, thermal expansion/contraction, etc., and hence the size of the light condensing spot of the position adjustment light with respect to a light receiving surface of the adjustment light receiving portion can be further increased as compared with the case of a light condensing spot of the signal light. Thus, the signal output of the adjustment light receiving portion with respect to the angle change of the light splitting element can be continuously changed in a wide angle range, unlike the case where the light condensing spot is small with respect to the light receiving surface so that the rotational position is adjusted in a narrow region in the vicinity of the optimum rotational position, and hence the optimum rotational position of the light splitting element can be easily found. Consequently, the light splitting element can be easily and promptly mounted (the rotational position of the light splitting element can be easily and promptly adjusted).

In the aforementioned optical pickup according to the first aspect, the light splitting element is preferably configured to generate first signal light including interfering light formed by a track groove of the optical disk and second signal light not including the interfering light by splitting the signal light and is preferably configured such that the light condensing position of the position adjustment light on a light receiving surface of the light receiving portion is arranged between the light condensing position of the first signal light and the light condensing position of the second signal light. According to this structure, in the light receiving portion, the adjustment light receiving portion is arranged between two signal light receiving portions for the first signal light and the second signal light employed for the optical disk signal processing in reproduction, provided at a prescribed angular interval (about 90 degrees, for example) previously set, and hence an increase in the overall size of the light receiving portion (the area of the light receiving surface) can be suppressed even when in addition to the signal light receiving portions, the adjustment light receiving portion is provided.

In the aforementioned optical pickup according to the first aspect, a light condensing spot of the position adjustment light on a light receiving surface of the light receiving portion preferably has such a shape that both ends of the light condensing spot of the position adjustment light in a circumferential direction about the light condensing position of 0th order light are arranged in a light receiving surface of the adjustment light receiving portion and in the vicinity of both ends of the light receiving surface of the adjustment light receiving portion in the circumferential direction. According to this structure, the rotational position of the light splitting element can be adjusted, utilizing a substantially entire area of the dimension in the circumferential direction of the adjustment light receiving portion in the case where the light splitting element is rotated in an operation of mounting the light spitting element. Consequently, the signal output of the adjustment light receiving portion can be changed in a wider rotation angle range, and hence the rotational position of the light splitting element can be more easily adjusted.

In this case, the width in the circumferential direction of the light condensing spot of the position adjustment light is preferably at least about 80% and not more than about 90% of the width in the circumferential direction of the adjustment light receiving portion. According to this structure, the light condensing spot of the position adjustment light does not protrude in the circumferential direction from the adjustment light receiving portion at a proper position, and the width of the light condensing spot of the position adjustment light can be sufficiently ensured with respect to the dimension in the circumferential direction of the adjustment light receiving portion.

In the aforementioned optical pickup according to the first aspect, a light condensing spot of the position adjustment light on a light receiving surface of the light receiving portion preferably has such a shape that the length of the light condensing spot of the position adjustment light in a radial direction about the light condensing position of 0th order light is larger than the length of the adjustment light receiving portion in the radial direction. According to this structure, the position adjustment light can be received by the adjustment light receiving portion even when an interval in an optical axis direction between the light receiving portion and the light splitting element is displaced from a design value due to an error in manufacturing or the like. In other words, the light condensing spot of the position adjustment light moves away from a light condensing spot of the 0th order light in the radial direction when the interval in the optical axis direction between the light receiving portion and the light splitting element is increased, and the light condensing spot of the position adjustment light comes close to the light condensing spot of the 0th order light in the radial direction when the interval in the optical axis direction between the light receiving portion and the light splitting element is reduced. According to the present invention, the length of the light condensing spot of the position adjustment light in the radial direction is larger than the length of the adjustment light receiving portion in the radial direction, whereby the light condensing spot of the position adjustment light can be arranged on the adjustment light receiving portion even when the light condensing spot of the position adjustment light is displaced in the radial direction.

In the aforementioned optical pickup according to the First aspect, the light splitting element is preferably configured such that a distance from the light condensing position of 0th order light to the light condensing position of the position adjustment light is larger than a distance from the light condensing position of the 0th order light to the light condensing position of the signal light on a light receiving surface of the light receiving portion. In the case where the optical disk is a multilayer disk, return light (so-called stray light) from a recording layer other than a recording layer to be reproduced (or to be recorded) is incident on the light receiving portion, and an output signal of the light receiving portion is degraded (the stray light becomes noise). When the light splitting element splits the return light to generate not only the signal light but also the position adjustment light, the stray light is split similarly, and the split stray light is condensed in the vicinity of the light condensing spots of the signal light and the position adjustment light. According to the present invention, the light splitting element is configured such that the distance from the light condensing position of the 0th order light to the light condensing position of the position adjustment light is larger than the distance from the light condensing position of the 0th order light to the light condensing position of the signal light, whereby the stray light condensed in the vicinity of the light condensing spot of the position adjustment light can be separated from the light condensing spot (i.e. the signal light receiving portion) of the signal light, and hence the stray light can be suppressed from being received by the signal light receiving portion.

In the aforementioned optical pickup according to the first aspect, the adjustment light receiving portion preferably includes a pair of light receiving regions bounded by a centerline extending in a radial direction about the light condensing position of 0th order light, and a light condensing spot of the position adjustment light on a light receiving surface of the light receiving portion preferably has such a shape that the areas of the light condensing spot on both sides through the centerline are equal to each other when a spot center is located on the centerline. According to this structure, in the case where the light splitting element is rotated in the operation of mounting the light spitting element, the rotational position of the light splitting element can be accurately specified by comparing the output signal levels of the pair of light receiving regions with each other when the spot center of the light condensing spot of the position adjustment light is arranged on the centerline between the pair of light receiving regions. Therefore, the light splitting element (and the light receiving portion is designed such that this position on the centerline is a proper mounting position, whereby the rotational position of the light splitting element can he easily adjusted with high accuracy.

In this case, the light condensing spot of the position adjustment light on the light receiving surface of the light receiving portion preferably has such a shape that both sides of the light condensing spot through the centerline are bilaterally symmetric when the spot center is located on the centerline. According to this structure, the areas of both sides of the light condensing spot through the centerline can be rendered equal to each other even when the light condensing spot of the position adjustment light is displaced in the radial direction due to the displacement of the interval in the optical axis direction between the light receiving portion and the light splitting element from the design value.

In the aforementioned structure in which the light condensing spot of the position adjustment light has such a shape that the areas of both sides of the light condensing spot through the centerline are equal to each other when the spot center is located on the centerline, the light condensing spot of the position adjustment light on the light receiving surface of the light receiving portion preferably has such a shape that the length of the light condensing spot in the radial direction in a central portion in a circumferential direction about the light condensing position of the 0th order light is maximized. According to this structure, changes in the light receiving areas of the light receiving regions can be increased when the spot center of the light condensing spot of the position adjustment light is in the vicinity of the centerline between the pair of light receiving regions in the adjustment of the rotational position of the light splitting element. In other words, the light receiving area of one of the light receiving regions is reduced, and the light receiving area of the other of the light receiving regions is increased when the spot center of the light condensing spot of the position adjustment light passes through the centerline between the pair of light receiving regions following the rotation of the light splitting element, for example. At this time, in the case where the length of the light condensing spot in the radial direction in the central portion is small and the light condensing spot has such a shape that the light condensing spot converges toward the spot center, for example, the length in the radial direction at the spot center crossing the centerline is small, so that the amount of change in the light receiving areas of the light receiving regions is reduced. On the other hand, in the case where the length of the light condensing spot in the radial direction in the central portion is maximized, the length in the radial direction crossing the centerline is large, so that the amount of change in the light receiving areas of the light receiving regions is increased. Thus, changes in the output signal levels at the rotational position in the vicinity of the centerline can be easily grasped, and hence the rotational position of the light splitting element can be more easily adjusted.

In this case, the light condensing spot of the position adjustment light on the light receiving surface of the light receiving portion preferably has a rhombic shape having a long axis along the radial direction and a short axis along the circumferential direction. According to this structure, such a light condensing spot shape that the length in the radial direction in the central portion in the circumferential direction is maximized, and the areas on both sides through the centerline are equal to each other and both sides through the centerline are bilaterally symmetric when the spot center is located on the centerline can be obtained.

In the aforementioned structure in which the light condensing spot of the position adjustment light has such a shape that the areas of both sides of the light condensing spot through the centerline are equal to each other when the spot center is located on the centerline, the light splitting element and the light receiving portion are preferably configured such that a light condensing spot of the signal light is located in the center of the signal light receiving portion when the spot center of the light condensing spot of the position adjustment light on the light receiving surface of the light receiving portion is located on the centerline. According to this structure, the spot center of the light condensing spot of the position adjustment light is arranged on the centerline between the pair of light receiving regions, whereby the light condensing spot of the signal light can be accurately located in the center of the signal light receiving portion in the case where the light splitting element is rotated in the operation of mounting the light splitting element.

In the aforementioned optical pickup according to the first aspect, the light splitting element preferably has a plurality of diffraction gratings splitting the return light into the signal light and the position adjustment light and dispersing the signal light and the position adjustment light in the different directions, and a diffraction grating for the position adjustment light of the diffraction gratings is preferably arranged in a central portion of a region of the light splitting element through which the return light from the optical disk penetrates. According to this structure, luminous flux (return light) in the central portion excluding the periphery employed for tracking control etc. of the region through which the return light penetrates is split, whereby the position adjustment light not employed for the optical disk signal processing but employed for the position adjustment can be easily generated.

In this case, the light splitting element preferably includes a hologram element formed with a plurality of diffraction patterns constituting the plurality of diffraction gratings. According to this structure, a light splitting grating having the plurality of diffraction gratings splitting the return light into the signal light and the position adjustment light and dispersing the signal light and the position adjustment light in the different directions can be easily obtained.

In the aforementioned structure in which the light splitting element has the plurality of diffraction gratings splitting the return light into the signal light and the position adjustment light and dispersing the signal light and the position adjustment light in the different directions, a plurality of diffraction gratings for the signal light of the diffraction gratings are preferably provided to surround the diffraction grating for the position adjustment light arranged in the central portion of the region of the light splitting element through which the return light penetrates. According to this structure, an increase in the size of the light splitting element can be suppressed by effectively utilizing the region (area) of the light splitting element through which the return light penetrates even when not only the diffraction gratings for the signal light but also the diffraction grating for the position adjustment light are provided in the light splitting element.

In the aforementioned structure in which the light condensing position of the position adjustment light on the light receiving surface of the light receiving portion is arranged between the light condensing position of the first signal light and the light condensing position of the second signal light, the light splitting element is preferably configured to diffract the position adjustment light toward a position in a direction dividing an angle between the diffraction direction of the first signal light from the light condensing position of 0th order light to the light condensing position of the first signal light and the diffraction direction of the second signal light from the light condensing position of the 0th order light to the light condensing position of the second signal light substantially equally on the light receiving surface of the light receiving portion. According to this structure, the increase in the overall size of the light receiving portion (the area of the light receiving surface) can be suppressed even when in addition to the signal light receiving portions, the adjustment light receiving portion is provided, and the light condensing position of the position adjustment light is separated equally from both the light condensing position of the first signal light and the light condensing position of the second signal light, so that the stray light condensed in the vicinity of the light condensing spot of the position adjustment light can be effectively suppressed from being received by the signal light receiving portion.

In the aforementioned structure in which the light condensing position of the position adjustment light on the light receiving surface of the light receiving portion is arranged between the light condensing position of the first signal light and the light condensing position of the second signal light, the light splitting element is preferably configured such that the light condensing position of the position adjustment light falls within a rectangular region using a distance from the light condensing position of 0th order light to the light condensing position of the first signal light and a distance from the light condensing position of the 0th order light to the light condensing position of the second signal light as the distances of sides on the light receiving surface of the light receiving portion. According to this structure, the increase in the overall size of the light receiving portion (the area of the light receiving surface) can be effectively suppressed even when in addition to the signal light receiving portion, the adjustment light receiving portion is provided.

An optical disk unit according to a second aspect of the present invention includes an optical pickup emitting light to an optical disk and detecting return light from the optical disk and a control portion performing reproduction control for the optical disk on the basis of an output signal of the optical pickup, while the optical pickup includes a light source emitting the light to the optical disk, a light splitting element generating signal light employed for optical disk signal processing and position adjustment light not employed for the optical disk signal processing by splitting the return light from the optical disk and dispersing the return light in different directions, and a light receiving portion having a signal light receiving portion receiving the signal light and an adjustment light receiving portion receiving the position adjustment light, and the light splitting element is configured such that the position thereof is adjusted on the basis of the position adjustment light received by the adjustment light receiving portion of the light receiving portion.

As hereinabove described, the optical disk unit according to the second aspect of the present invention is provided with the light splitting element generating the position adjustment light not employed for the optical disk signal processing and the light receiving portion having the adjustment light receiving portion receiving the position adjustment light, and the light splitting element is configured such that the position thereof is adjusted on the basis of the position adjustment light received by the adjustment light receiving portion of the light receiving portion, whereby the rotational position of the light splitting element can be adjusted, using the position adjustment light for position adjustment not employed for the signal processing (signal reproduction, tracking control, etc.) when the disk is reproduced and the adjustment light receiving portion. In this case, as to the position adjustment light not employed for the signal processing and the adjustment light receiving portion, it is not necessary to consider the positional displacement of a light condensing spot resulting from change with time, thermal expansion/contraction, etc., and hence the size of the light condensing spot of the position adjustment light with respect to a light receiving surface of the adjustment light receiving portion can be further increased as compared with the case of a light condensing spot of the signal light. Thus, the signal output of the adjustment light receiving portion with respect to the angle change of the light splitting element can be continuously changed in a wide angle range, unlike the case where the light condensing spot is small with respect to the light receiving surface so that the rotational position is adjusted in a narrow region in the vicinity of the optimum rotational position, and hence the optimum rotational position of the light splitting element can be easily found. Consequently, the light splitting element can be easily and promptly mounted (the rotational position of the light splitting element can be easily and promptly adjusted).

In the aforementioned optical disk unit according to the second aspect, the light splitting element is preferably configured to generate first signal light including interfering light formed by a track groove of the optical disk and second signal light not including the interfering light by splitting the signal light and is preferably configured such that the light condensing position of the position adjustment light on a light receiving surface of the light receiving portion is arranged between the light condensing position of the first signal light and the light condensing position of the second signal light. According to this structure, in the light receiving portion, the adjustment light receiving portion is arranged between two signal light receiving portions for the first signal light and the second signal light employed for the optical disk signal processing an reproduction, provided at a prescribed angular interval (about 90 degrees, for example) previously set, and hence an increase in the overall size of the light receiving portion (the area of the light receiving surface) can be suppressed even when in addition to the signal light receiving portions, the adjustment light receiving portion is provided.

In the aforementioned optical disk unit according to the second aspect, a light condensing spot of the position adjustment light on a light receiving surface of the light receiving portion preferably has such a shape that both ends of the light condensing spot of the position adjustment light in a circumferential direction about the light condensing position of 0th order light are arranged in a light receiving surface of the adjustment light receiving portion and in the vicinity of both ends of the light receiving surface of the adjustment light receiving portion in the circumferential direction. According to this structure, the rotational position of the light splitting element can be adjusted, utilizing a substantially entire area of the dimension in the circumferential direction of the adjustment light receiving portion in the case where the light splitting element is rotated in an operation of mounting the light spitting element. Consequently, the signal output of the adjustment light receiving portion can be changed in a wider rotation angle range, and hence the rotational position of the light splitting element can be more easily adjusted.

In the aforementioned optical disk unit according to the second aspect, the adjustment light receiving portion preferably includes a pair of light receiving regions bounded by a centerline extending in a radial direction about the light condensing position of 0th order light and a light condensing spot of the position adjustment light on a light receiving surface of the light receiving portion preferably has such a shape that the areas of the light condensing spot on both sides through the centerline are equal to each other when a spot center is located on the centerline. According to this structure, in the case where the light splitting element is rotated in the operation of mounting the light spitting element the rotational position of the light splitting element can be accurately specified by comparing the output signal levels of the pair of light receiving regions with each other when the spot center of the light condensing spot of the position adjustment light is arranged on the centerline between the pair of light receiving regions. Therefore, the light splitting element (and the light receiving portion) is designed such that this position on the centerline is a proper mounting position, whereby the rotational position of the light splitting element can be easily adjusted with high accuracy.

According to the present invention, as hereinabove described, the light splitting element can be easily and promptly mounted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing the overall structure of an optical disk unit according to an embodiment of the present invention;

FIG. 2 is a schematic view showing the structure of an optical pickup of the optical disk unit according to the embodiment of the pre sent invention;

FIG. 3 is a schematic view showing diffraction regions of a light splitting element of the optical pickup according to the embodiment of the present invention;

FIG. 4 is an image diagram showing diffraction patterns formed in the diffraction regions of the light splitting element;

FIG. 5 is a schematic view showing the arrangement of light receiving elements and the positions of light condensing spots on a light receiving surface of a light receiving portion of the optical pickup;

FIG. 6 is an enlarged view for illustrating a light condensing spot of position adjustment light and a light receiving element for the position adjustment light shown in FIG. 5; and

FIG. 7 is an image diagram showing an example of a diffraction pattern of a light splitting element of an optical pickup according to a modification of the embodiment of the present invention.

### DESCRIPTION OF THE PREFERRED EMBODIMENTS

An embodiment of the present invention is hereinafter described with reference to the drawings.

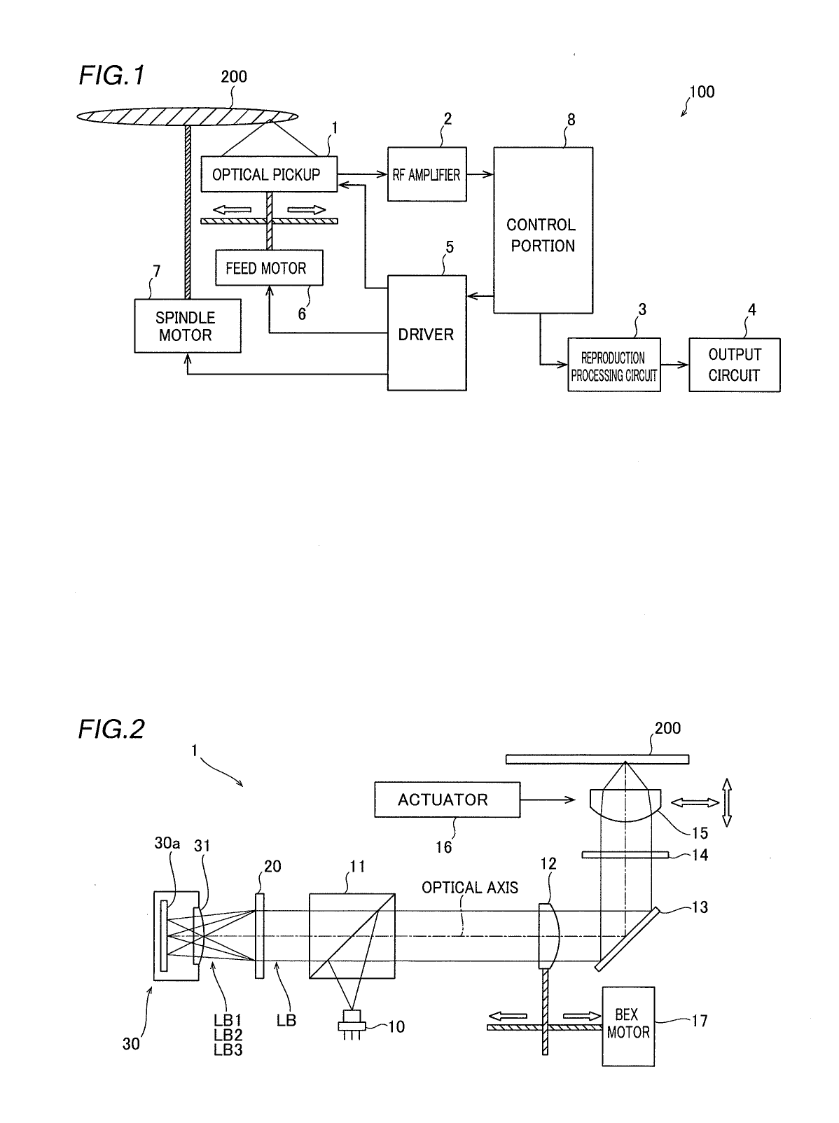

The structure of an optical disk unit 100 according to the embodiment of the present invention is now described with reference to FIG. 1.

The optical disk unit 100 according to this embodiment is configured to be capable of reproducing a BD (Blu-ray (registered trademark) Disc) or the like as an optical disk 200. Specifically, the optical disk unit 100 includes an optical pickup 1, an RE amplifier 2, a reproduction processing circuit 3, and an output circuit 4. The optical disk unit 100 further includes a driver 5, a feed motor 6, a spindle motor 7, and a control portion 8.

The optical pickup 1 has a function of reading various types of information (sound information, image information, etc.) recorded in the optical disk 200 by emitting a laser beam (optical beam) to the optical disk 200 and detecting return light from the optical disk 200. The detailed structure of the optical pickup 1 is described later.

The RF amplifier 2 has a function of amplifying a signal based on the various types of information read by the optical pickup 1. The reproduction processing circuit 3 is configured to acquire the signal amplified by the RF amplifier 2 through the control portion 8 and perform various types of processing (image processing, for example) for reproduction on the signal. The output circuit 4 is configured to perform D/A conversion processing on the signal on which the reproduction processing circuit 3 performs the processing in order to output the image and sound recorded in the optical disk 200 through an unshown monitor and an unshown speaker, respectively.

The driver 5 is configured to control the operation of the feed motor 6 and the spindle motor 7 on the basis of an instruction from the control portion 8. Furthermore, the driver 5 is configured to control the operation of an actuator 16 and a BEX (beam expander) motor 17 (see FIG. 2) described later, provided inside the optical pickup 1 on the basis of an instruction from the control portion 8. The feed motor 6 has a function of moving the optical pickup 1 in the radial direction of the optical disk 200. The spindle motor 7 has a function of rotating the optical disk 200.

The control portion 8 is configured to generate a reproduction signal, a focus error (FE) signal, and a tracking error (TE) signal on the basis of a signal output from a light receiving portion 30 (see FIG. 2) described later, provided inside the optical pickup 1. The control portion 8 is configured to perform focus servo control on the basis of the FE signal and perform tracking servo control on the basis of the TE signal when the optical disk 200 is reproduced.

The structure of the optical pickup 1 of the optical disk unit 100 according to this embodiment is now described with reference to FIGS. 2 to 6.

As shown in FIG. 2, the optical pickup 1 mainly includes a light source 10, a half mirror 11, a collimator lens 12, a mirror 13, a ¼ wavelength plate 14, an objective lens 15, the actuator 16, the BEX motor 17, a light splitting element 20, and the light receiving portion 30. These portions constituting the optical pickup 1 are housed in an unshown case in a state where theses portions are properly positioned.

The light source 10 includes an LD capable of emitting a blue laser beam having a 405 nm band for the BD.

The half mirror 11 is configured to reflect the laser beam emitted from the light source 10 and allows the return light from the optical disk 200 to penetrate.

The collimator lens 12 has a function of converting the laser beam from the side of the half mirror 11 into parallel light. The collimator lens 12 is configured to be movable in an optical axis direction by the BEX motor 17. The collimator lens 12 is moved in the optical axis direction, whereby the laser beam penetrating through the collimator lens 12 becomes diverging light or convergent light. Thus, the spherical aberration of the optical pickup 1 is adjusted.

The mirror 13 reflects the laser beam from the side of the collimator lens 12 toward the optical disk 200 and reflects reflected light reflected by the optical disk 200 toward the collimator lens 12. The mirror 13 is configured to reflect the laser beam from the side of the collimator lens 12 in a direction substantially orthogonal to a recording surface of the optical disk 200.

The 1/4 wavelength plate 14 has a function of converting linearly polarized light into circularly polarized light and converting circularly polarized light into linearly polarized light. The ¼ wavelength plate 14 converts a linearly polarized laser beam from the side of the mirror 13 into a circularly polarized laser beam and guides the circularly polarized laser beam to the objective lens 15 and converts a circularly polarized laser beam (return light) reflected by the optical disk 200 into a linearly polarized, laser beam and guides the linearly polarized, laser beam to the mirror 13.

The objective lens 15 has a function of condensing the laser beam from the side of the mirror 13 on the recording surface of the optical disk 200. The objective lens 15 is configured to he moveable in a direction (focus direction) orthogonal to the recording surface of the optical disk 200 and in the radial direction (tracking direction) of the optical disk 200 by the actuator 16, and the position is moved by the focus servo control and the tracking servo control.

The actuator 16 moves the objective lens 15 in the radial direction of the optical disk 200 on the basis of an objective lens driving signal generated by the driver 5 (see FIG. 1). Thus, tracking operation is performed. Furthermore, the actuator 16 moves the objective lens 15 in the direction orthogonal to the recording surface of the optical disk 200 on the basis of the objective lens driving signal generated by the driver 5. Thus, focus operation is performed.

The return light reflected by the optical disk 200 reaches the light splitting element 20 through the objective lens 15, the ¼ wavelength plate 14, the mirror 13, the collimator lens 12, and the half mirror 11. The light splitting element 20 includes a hologram element formed with a plurality of diffraction patterns (diffraction gratings), splits the return light from the optical disk 200, and disperses the split light in different directions. Thus, the light splitting element 20 is configured to generate signal light (first signal light LB1 and second signal light LB2 described later) employed for signal processing of the optical disk 200 and position adjustment light LB3 not employed for the signal processing of the optical disk 200. The first signal light Lai and the second signal light LB2 are examples of the “signal light” in the present invention.

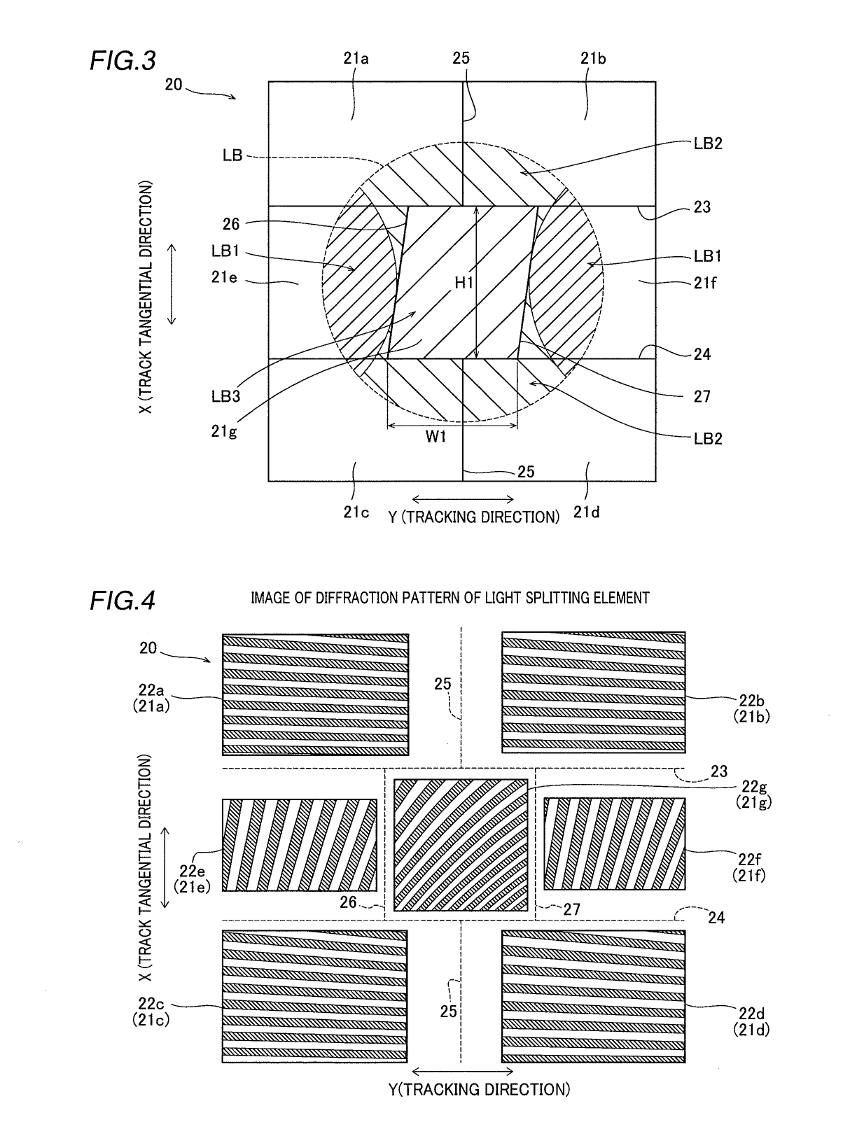

As shown in FIG. 3, the light splitting element 20 is arranged to receive the luminous flux LB of the return light in the center of a light receiving surface thereof. The light splitting element 20 has seven diffraction regions 21a to 21g by splitting the rectangular light receiving surface into seven parts. In FIG. 3, of an X-axis and a Y-axis orthogonal to each other, the Y-axis denotes the tracking direction, and the X-axis denotes a track tangential direction. As shown in FIG. 4, these diffraction regions 21a to 21g are formed with diffraction patterns (diffraction gratings) 22a to 22g different from each other. In FIG. 4, the diffraction patterns 22a to 22g of the diffraction regions 21a to 21g are arranged in correspondence to the arrangement of the diffraction regions 21a to 21g in FIG. 3 for the convenience of illustration. The diffraction patterns 22a to 22g are examples of the “diffraction gratings” in the present invention.

As shown in FIG. 2, the light receiving portion 30 includes a cylindrical lens 31 and a plurality of light receiving elements described later. The cylindrical lens 31 condenses the signal light (the first signal light LB1 and the second signal light LB2) and the position adjustment light LB3 on the light receiving elements provided on a light receiving surface 30a of the light receiving portion 30. The light receiving portion 30 converts optical information received by the light receiving elements such as photodiodes into an electrical signal and has a function of outputting the electrical signal to the control portion 8 (see FIG. 1).

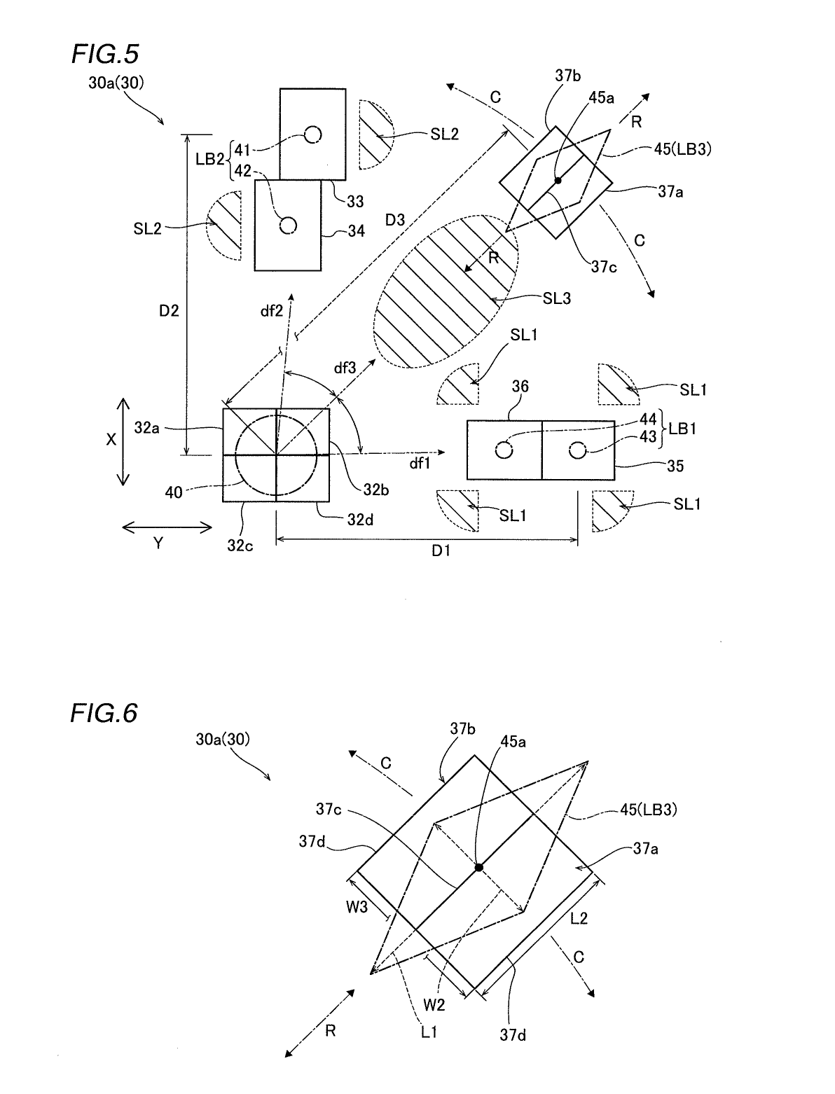

The light receiving portion 30 includes four main Light receiving elements 32a, 32b, 32c, and 32d equally split in a longitudinal direction and in a transverse direction, light receiving elements 33, 34, 35, and 36, and a pair of light receiving elements 37a and 37b, as shown in FIG. 5. The light receiving portion 30 is configured to individually perform photoelectric conversion for each light receiving element and output the electrical signal. The main light receiving elements 32a to 32d are light receiving elements splitting 0th order diffraction light (main beam) in quarters and receiving the light. As described later, the light receiving elements 33 to 36 are light receiving elements receiving the signal light (the first signal light LB1 and the second signal light LB2), and the light receiving elements 37a and 37b are light receiving elements receiving the position adjustment light LB3. The light receiving elements 33 to 36 are examples of the “signal light receiving portion” in the present invention. The light receiving elements 37a and 37b are examples of the “adjustment light receiving portion” and the “light receiving regions” in the present invention, respectively.

The configuration of each of the diffraction regions 21a to 21g of the light splitting element 20 and the arrangement of each of the light receiving elements 33 to 36 and the light receiving elements 37a and 37b of the light receiving portion 30 are now described.

As shown in FIG. 3, first, the light splitting element 20 is split into three parts in a direction X by parting lines 23 and 24 extending in a direction Y, and two regions on both sides in the direction X of the split three parts are split into two parts in the direction Y by parting lines 25 extending in the direction X. Thus, the two diffraction regions 21a and 21b and the two diffraction regions 21c and 21d split in the tracking direction (direction Y) on both sides in the track tangential direction (direction X) are formed.

A central region (between the parting lines 23 and 24) in the direction X is split into three parts in the direction Y by a pair of inclined parting lines 26 and 27 formed on both sides through a central portion in the direction Y. Thus, in a central portion in the track tangential direction (direction X), the diffraction regions 21e and 21f on both sides in the tracking direction (direction Y) and the diffraction region 21g in the center in the direction Y are formed. According to this embodiment, the pair of inclined parting lines 26 and 27 are parallel to each other, and the diffraction region 21g is parallelogram-shaped. The width of the base (the side extending in the direction Y) of the diffraction region 21g is W1, and the height (the height in the direction X) of the diffraction region 21g from the base is H1.

These diffraction regions 21a to 21g generate the first signal light LB1 split in both side portions in the tracking direction (direction Y), the second signal light LB2 split in both side portions in the track tangential direction (direction X), and the position adjustment light LB3 split in a central portion of a region through which the luminous flux LB penetrates from the luminous flux LB of a laser beam penetrating through the light splitting element 20. The first signal light LB1 is signal light obtained by splitting a portion including interfering light (±1st order light) formed by a track groove of the optical disk 200 of the luminous flux LB, and the second signal light LB2 is signal light obtained by splitting a portion not including the interfering light (±1st order light) formed by the track groove of the optical disk 200 of the luminous flux LB. The position adjustment light LB3 is split light whose light receiving signal is not employed as a TE signal for the tracking servo control, a reproduction signal of the optical disk 200, or the like (not employed for optical disk signal processing) and split light dedicated for position adjustment of the light splitting element 20 employed only when the light splitting element 20 is mounted as described later. The diffraction regions 21a. to 21g are configured to diffract the first signal light LB1, the second signal light LB2, and the position adjustment light LB3 into which the luminous flux LB is split in different directions on the basis of the formed diffraction patterns 22a to 22g (see FIG. 4) and condense the light on the light receiving portion 30. The diffraction regions 21a to 21f are diffraction regions for signal light and diffraction regions for position adjustment light. A plurality of diffraction regions (21a to 21f) for signal light are provided to surround the diffraction region 21g for the position adjustment light LB3 arranged in the central portion of the region through which the return light (luminous flux LB) penetrates.

More specifically, the second signal light LB2 generated by the diffraction regions 21a and 21c (see FIG. 3) on one side in the tracking direction (direction Y) is diffracted substantially in the direction X (direction df2) and forms a circular light condensing spot 41 on the light receiving surface 30a of the light receiving portion 30, as shown in FIG. 5. Furthermore, the second signal light LB2 generated by the diffraction regions 21b and 21d (see FIG. 3) on the other side in the tracking direction (direction Y) is diffracted substantially in the direction X (direction df2) and forms a circular light condensing spot 42 on the light receiving surface 30a of the light receiving portion 30. The light condensing spot 42 is formed at a position closer to a light condensing spot of the 0th order light (hereinafter referred to as a 0th order light spot 40) than the light condensing spot 41. At the positions of these light condensing spots 41 and 42, the light receiving elements 33 and 34 are arranged, respectively.

The first signal light LB1 generated by the diffraction region 21e (see FIG. 3) on one side in, the tracking direction (direction Y) in the central portion in the direction X is diffracted substantially in the direction Y (direction df1) and forms a circular light condensing spot 43 on the light receiving surface 30a of the light receiving portion 30. The first signal light LB1 generated by the diffraction region 21f (see FIG. 3) on the other side in the tracking direction (direction Y) is diffracted substantially in the direction Y (direction df1) and forms a circular light condensing spot 44 on the light receiving surface 30a of the light receiving portion 30. The light condensing spot 44 is formed at a position closer to the 0th order light spot 40 than the light condensing spot 43. At the positions of these light condensing spots 43 and 44, the light receiving elements 35 and 36 are arranged, respectively,

Thus, the second signal light LB2 split in half in the track tangential direction (direction X) is received by the light receiving element 33 (light condensing spot 41) and the light receiving element 34 (light condensing spot 42), and the first signal light LB1 split in half in the tracking direction (direction Y) is received by the light receiving element 35 (light condensing spot 43) and the light receiving element 36 (light condensing spot 44). The control portion 8 generates TE signals from output signals of these light receiving elements 33 to 36 and performs the tracking servo control.

On the other hand, the position adjustment light LB3 generated by the diffraction region 21g (see FIG. 3) in the center is diffracted toward a position between the light condensing position light condensing spots 43 and 44) of the first signal light LB1 and the light condensing position (light condensing spots 41 and 42) of the second signal light LB2 in a circumferential direction C using the 0th order light spot 40 as the center and forms a light condensing spot 45 on the light receiving surface 30a of the light receiving portion 30, as shown in FIG. 5. At the position of the light condensing spot 45, the two light receiving elements 37a and 37b aligning in the circumferential direction C are arranged using a radial direction R about the 0th order light spot 40 as a boundary.

The position adjustment light LB3 is diffracted in a diffraction direction df3 dividing an angle between the diffraction direction df1 of the first signal light LB1 and the diffraction direction df2 of the second signal light LB2 substantially equally. The position adjustment light LB3 is diffracted such that a distance D3 between the light condensing position (spot center 45a) of the position adjustment light LB3 and the 0th order light spot 40 is larger than a distance D1 between the light condensing position of the first signal light LB1 and the 0th order light spot 40 and a distance D2 between the light condensing position of the second signal light LB2 and the 0th order light spot 40 (the light condensing position (spot center 45a) of the position adjustment light LB3 is farther from the 0th order light spot 40). The light condensing position (spot center 45a) of the light condensing spot 45 falls within a rectangular region using the distances D2 and D1 as the distances of sides.

The light condensing spot 45 of the position adjustment light LBS has a rhombic shape having a long axis (longer diagonal line) along the radial direction R about the 0th order light spot 40 and a short axis (shorter diagonal line) along the circumferential direction C (the tangential direction of C), as shown in FIG. 6. Therefore, the light condensing spot 45 has such a shape that the length L1 in the radial direction R in a central portion in the circumferential direction C about the 0th order light spot 40 is maximized. The length L1 (maximum length) of the light condensing spot 45 in the radial direction R is larger than the length L2 of the two light receiving elements 37a and 37b in the radial direction R, and the light condensing spot 45 protrudes in the radial direction P from the light receiving elements 37a and 37b.

The light condensing spot 45 has such a shape (width W2) that both ends of the light condensing spot 45 in the circumferential direction C (short axis direction) are arranged in light receiving surfaces of the two light receiving elements 37a and 37b and in the vicinity of both ends 37d in the circumferential direction C in a state where the spot center 45a is located on a centerline (boundary line) 37c between the two light receiving elements 37a and 37b. According to this embodiment, the width W2 of the light condensing spot 45 is preferably about 80 to 90% of the total width W3 of the light receiving elements 37a and 37b. The light condensing spot 45 has such a shape that the areas thereof on both sides through the centerline 37c are equal to each other when the spot center 45a is located on the centerline 37c. According to this embodiment, the light condensing spot 45 is bilaterally symmetric along the circumferential direction C.

The light, splitting element 20 and the light receiving portion 30 are configured such that the light condensing spots 41 to 44 are located at the centers of the light receiving elements 33 to 36, respectively, in the state where the spot center 45a of the light condensing spot 45 is located on the centerline 37c between the two light receiving elements 37a and 37b (at a rotational position), as shown in FIG. 5.

This light splitting element 20 is achieved by forming the diffraction patterns 22a so 22g of the diffraction regions 21a to 21g in correspondence to the light condensing spots 41 to 45 of the light receiving elements of the light receiving portion 30.

The diffraction patterns of the diffraction regions are expressed by the following phase function Φ.

Φ[rad]=a₁+a₂x+a₃y+a₄x²+a₅xy+a₆y²

The x [mm] and y [mm] represent positions in an X-axis direction and a Y-axis direction, respectively. The coefficients a₁ to a₃ are coefficients related to a grating interval size, and the coefficients a₄ to a₆ are coefficients related to the curvature of a slit of a crating pattern. The coefficients a₁ to a₆ of the phase function are properly set, whereby the diffraction patterns 22a to 22g for realizing the aforementioned structure (the positions and shapes of the light condensing spots 41 to 45) are determined with respect to the diffraction regions 21a to 21g, respectively. The shapes of the light condensing spots are also varied according to the shapes of the diffraction regions 21a to 21g in addition to the phase function Φ. The light condensing spot 45 is formed in the rhombic shape having the length L1 in the radial direction R shown in FIG. 6 and the width W2 in the circumferential direction C by the diffraction pattern 22g shown in FIG. 4 and the parallelogram-shaped diffraction region 21g shown in FIG. 3.

The position adjustment of the light splitting element 20 performed when the light splitting element 20 is mounted in the optical pickup 1 is now described. As described above, each part constituting the optical pickup 1 is fixedly mounted in the unshown case such that the optical positional relationship (the positional relationship between the light condensing spots and the light receiving elements) shown in FIG. 5 is maintained. When the light splitting element 20 is mounted, the mounting position of the light splitting element 20 is adjusted while actually, the return light is received and the output signals of the light receiving elements are detected. The mounting position adjustment is to properly arrange the light splitting element 20 in an orthogonal surface direction with respect to the optical axis direction of the return light and thereafter adjust the rotational position of the light splitting element 20 about the optical axis.

When the light splitting element 20 is rotated about the optical axis, the light condensing spots 41 to 45 shown in FIG. 5 are rotated in the circumferential direction C about the light condensing position (0th order light spot 40) of the 0th order light that is the center of the optical axis. According to this embodiment, the light splitting element 20 is configured such that the position thereof is adjusted on the basis of the position adjustment light LB3 received by the light receiving elements 37a and 37b of the light receiving portion 30. In other words, the rotational position of the light splitting element 20 is adjusted on the basis of the light receiving signal of the position adjustment light LB3 condensed as the light condensing spot 45 (the output signals of the light receiving elements 37a and 37b).

Specifically, the light receiving area of the light receiving element 37a the area of a portion of the light condensing 45 overlapping with the light receiving element 37a) and the light receiving area of the light receiving element 37b are equal to each other in the state were the spot center 45a of the light condensing spot 45 is located on the centerline 37c between the light receiving elements 37a and the 37b, as shown in FIGS. 5 and 6, and hence the output signal level of the light receiving element 37a and the output signal level of the light receiving element 37b are equal to each other. When the light condensing spot 45 is displaced to either the left or the right in the circumferential direction C, on the other hand, the output signal level of the light receiving element 37a and the output signal level of the light receiving element 37b are different from each other. Therefore, the light splitting element 20 is rotated about the optical axis while the output signal levels of the light receiving element 37a and the light receiving element 37b are monitored, and the rotational position (the position of the spot center 45a arranged on the centerline 37c) where the output signal level of the light receiving element 37a and the output signal level of the light receiving element 37b are equal to each other corresponds to the mounting position (rotational position) of the light splitting element 20. At this time, the light condensing spots 41 to 44 are also arranged in the centers of the light receiving elements 33 to 36, respectively, as described above. When the mounting position is determined, the light splitting element 20 is fixed in the case by fixing means such as an adhesive agent, for example.

Actually, the position of the light splitting element 20 in the optical axis direction (see FIG. 2) may be displaced back and forth from a design value due to an error in manufacturing of each part of an optical system or the like. Consequently, when the light splitting element 20 comes close to the light receiving portion 30, the light, condensing spot 45 moves in the radial direction R and comes close to the 0th order light spot 40. When the light splitting element 20 moves away from the light receiving portion 30, on the other hand, the light condensing spot 45 moves away from the 0th order light spot 40 in the radial direction R. According to this embodiment, the length L1 of the light condensing spot 45 in the radial direction R is larger than the length L2 of the light receiving elements 37a and 37b in the radial direction R, and hence the output signals of the light receiving elements 37a and 37b can be sufficiently extracted even when the light splitting element 20 is displaced in the optical axis direction (from a design position).

In the case where the optical disk 200 is a multilayer disk, return light (so-called stray light) from a recording layer other than a recording layer to be reproduced (or to be recorded) is incident on the light receiving portion 30, and the output signal of the light receiving portion 30 is degraded (the stray light becomes noise). When the light splitting element 20 splits the return light to generate not only the signal light (the first signal light LB1 and the second signal light LB2) but also the position adjustment light LB3, the stray light is split similarly, and stray light SL1, stray light SL2, and stray light SL3 are condensed in the vicinity of the light condensing spots 41 to 45 on the light receiving surface 30a, for example. According to this embodiment, as described above, the light splitting element 20 is configured such that the distance D3 from the 0th order light spot 40 to the light condensing spot 45 is larger than the distances D1 and D2 from the 0th order light spot 40 to the light condensing spots of the signal light (the first signal light LB1 and the second signal light LB2) on the light receiving surface 30a of the light receiving portion 30. Thus, the stray light SL3 (the stray light diffracted by the diffraction region 21g) condensed in the vicinity of the light condensing spot 45 can be separated from the light condensing spots (i.e. the main light receiving elements 32a to 32d and the light receiving elements 33 to 36) of the signal light, and hence the stray light SL3 can be suppressed from being received by the main light receiving elements 32a to 32d and the light receiving elements 33 to 36.

According to this embodiment, as hereinabove described, the optical pickup 1 is provided with the light splitting element 20 generating the position adjustment light LB3 and the light receiving portion 30 having the light receiving elements 37a and 37b receiving the position adjustment light LB3, and the light splitting element 20 is configured such that the position thereof is adjusted on the basis of the position adjustment light LB3 received by the light receiving elements 37a and 37b of the light receiving portion 30, whereby the rotational position of the light splitting element 20 can be adjusted, using the position adjustment light LB3 for the position adjustment not employed for the signal processing (signal reproduction, tracking control, etc.) when the disk is reproduced and the light receiving elements 37a and 37b. In this case, the size of the light condensing spot 45 of the position adjustment light LB3 with respect to the light receiving surfaces of the light receiving elements 37a and 37b can be further increased as compared with the cases of the light condensing spots 41 to 44 of the signal light. Thus, the signal outputs of the light receiving elements 37a and 37b with respect to the rotation angle change of the light splitting element 20 can be continuously changed not in a narrow range in the vicinity of the optimum rotational position but in a wide angle range, and hence the optimum rotational position of the light splitting element 20 can be easily found. Consequently, the light splitting element 20 can be easily and promptly mounted (the rotational position of the light splitting element 20 can be easily and promptly adjusted).

According to this embodiment, the light splitting element 20 is configured such that the light condensing position (light condensing spot 45) of the position adjustment light LB3 is arranged between the light condensing position (light condensing spots 43 and 44) of the first signal light LB1 and the light condensing position (light condensing spots 41 and 42) of The second signal light LB2. Thus, in the light receiving portion 30, the light receiving elements 37a and 37b are arranged between the light receiving elements 33 to 36 for the first signal light LB1 and the second signal light LB2 provided at prescribed angular intervals previously set, and hence an increase in the overall size of the light receiving portion 30 (the area of the light receiving surface 30a) can be suppressed even when in addition to the light receiving elements 33 to 36, the light receiving elements 37a and 37b are provided.

According to this embodiment, the light condensing spot 45 of the position adjustment light LB3 is formed in such a shape that both ends of the light condensing spot 45 of the position adjustment light LB3 in the circumferential direction C are arranged in the light receiving surfaces of the light receiving elements 37a and 37b and in the vicinity of both ends 37d of the light receiving surface in the circumferential direction C. Thus, the rotational position of the light splitting element 20 can be adjusted, utilizing a substantially entire area of the dimension in the circumferential direction C of the light receiving elements 37a and 37b in the case where the light splitting element 20 is rotated in an operation of mounting the light spitting element 20. Consequently, the signal outputs of the light receiving elements 37a and 37b can be changed in a wider rotation angle range, and hence the rotational position of the light splitting element 20 can be more easily adjusted. The width W2 in the circumferential direction C of the light condensing spot 45 of the position adjustment light LB3 is preferably at least about 80% and not more than about 90% of the total width W3 of the light receiving elements 37a and 37b. Thus, the light, condensing spot 45 of the position adjustment light LB3 does not protrude in the circumferential direction C from the light receiving elements 37a and 37b at a proper position, and the width (width W2) of the light condensing spot of the position adjustment light can be sufficiently ensured with respect to the dimension (width W3 in the circumferential direction C of the light receiving elements 37a and 37b.

According to this embodiment, the light condensing spot 45 of the position adjustment light LB3 is formed in such a shape that the areas thereof on both sides through the centerline 37c are equal to each other when the spot center 45a is located on the centerline 37c. Thus, in the case where the light splitting element 20 is rotated in the operation of mounting the light spitting element 20, the rotational position of the light splitting element 20 can be accurately specified by comparing the output signal levels of the pair of light receiving elements 37a and 37b with each other when the spot center 45a of the light condensing spot 45 is arranged on the centerline 37c. Therefore, the rotational position of the light splitting element 20 can be easily adjusted with high accuracy.

According to this embodiment, the light condensing spot 45 of the position adjustment light LB3 is formed in such a shape that both sides thereof through the centerline 37c are bilaterally symmetric when the spot center 45a is located on the centerline 37c. Thus, the areas of both sides of the light condensing spot 45 through the centerline 37c can be rendered equal to each other even when the light condensing spot of the position adjustment light LB3 is displaced in, the radial direction R.

According to this embodiment, the light condensing spot 45 of the position adjustment light LB3 is formed in such a shape that the length L1 thereof in the radial direction R in the central portion in the circumferential direction C is maximized. Thus, changes in the light receiving areas of the light receiving elements 37a and 37b can be increased when the spot center 45a of the light condensing spot 45 is in the vicinity of the centerline 37c in the adjustment of the rotational position of The light splitting element 20. In other words, the light receiving area of the light receiving element 37a is reduced, and the light receiving area of the light receiving element 37b is increased when the spot center 45a of the light condensing spot 45 passes through the centerline 37c from the side of the light receiving element 37a to the side of the light receiving element 37b following the rotation of the light splitting element 20. At this time, in the case where the length of the light condensing spot in the radial direction R in the central portion is small and the light condensing spot has such a shape that the light condensing spot converges toward the spot center, for example, the length in the radial direction R at the spot center crossing the centerline 37c is small, so that the amount of change in the light receiving areas of the light receiving elements 37a and 37b is reduced. On the other hand, in the case where the length L1 of the light condensing spot 45 in the radial direction R in the central portion is maximized, the length in the radial direction R crossing the centerline 37c is large, so that the amount of change in the light receiving areas of the light receiving elements 37a and 37b is increased. Thus, according to this embodiment, changes in the output signal levels at the rotational position in the vicinity of the centerline 37c can be easily grasped, and hence the rotational position of the light splitting element 20 can be more easily adjusted.

According to this embodiment, the light condensing spot 45 of the position adjustment light LB3 is formed in the rhombic shape having the long axis along the radial direction R and the short axis along the circumferential direction C. Thus, such a light condensing spot shape that the length L1 in the radial direction A in the central portion in the circumferential direction C is maximized, and the areas on both sides through the centerline 37c are equal to each other and both sides through the centerline 37c are bilaterally symmetric when the spot center 45a is located on the centerline 37c can be obtained.

According to this embodiment, the light splitting element 20 and the light receiving portion 30 are configured such that the light condensing spots 41 to 44 of the signal light are located in the centers of the light receiving elements 33 to 36, respectively when the spot center 45a of the light condensing spot 45 is located on the centerline 37c. Thus, the spot center 45a of the light condensing spot 45 of the position adjustment light LB3 is arranged on the centerline 37c between the light receiving elements 37a and 37b, whereby the light condensing spots 41 to 44 of the signal light can be accurately located in the centers of the light receiving elements 33 to 36, respectively in the case where the light splitting element 20 is rotated in the operation of mounting the light splitting element 20.

According to this embodiment, the light splitting element 20 is provided with the plurality of diffraction patterns 22a to 22g (diffraction regions 21a to 21g), and the diffraction pattern 22g (diffraction region 21g) for the position adjustment light LB3 is arranged in the central portion (diffraction region 21g) of the region of the light splitting element 20 through which the return light (luminous flux LB) from the optical disk 200 penetrates. Thus, luminous flux in the central portion excluding the periphery (the diffraction regions 21a to 21f of the first signal light LB1 and the second signal light LB2) employed for tracking control etc. of the luminous flux LB is split, whereby the position adjustment light LB3 not employed for the optical disk signal processing but employed for the position adjustment can be easily generated.

According to this embodiment, the light splitting element 20 includes the hologram element formed with the plurality of diffraction patterns 22a to 22g constituting the plurality of diffraction regions 21a to 21g, respectively. Thus, a light splitting grating having the plurality of diffraction gratings (diffraction patterns 22a to 22g) splitting the return light into the signal light (LB1 and LB2) and the position adjustment light LB3 and dispersing the signal light (LB1 and LB2) and the position adjustment light LB3 in the different directions can be easily obtained.

According to this embodiment, the plurality of diffraction regions 21a to 21f (diffraction patterns 22a to 22f) for the signal light are provided to surround the diffraction region 21g for the position adjustment light LB3 arranged in the central portion of the region of the light splitting element 20 through which the return light (luminous flux LB) penetrates. Thus, an increase in the size of the light splitting element 20 can be suppressed by effectively utilizing the region (area) of the light splitting element 20 through which the return light (luminous flux LB) penetrates.

According to this embodiment, the light splitting element 20 is configured to diffract the position adjustment light LB3 in the diffraction direction df3 dividing the angle between the diffraction direction df1 of the first signal light LB1 and the diffraction direction df2 of the second. signal light LB2 substantially equally. Thus, the increase in the overall size of the light receiving portion 30 (the area of the light receiving surface 30a) can be suppressed, and the light condensing position of the position adjustment light LB3 is separated equally from both the light condensing position (light condensing spots 43 and 44) of the first signal light LB1 and the light condensing position (light condensing spots 41 and 42) of the second signal light LB2, so that the stray light condensed in the vicinity of the light condensing spot 45 of the position adjustment light LB3 can be effectively suppressed from being received by the light receiving elements 33 to 36.

According to this embodiment, the light splitting element 20 is configured such that the light condensing position (spot center 45a) of the position adjustment light LB3 falls within the rectangular region using the distance D1 from the 0th order light spot 40 to the light condensing position of the first signal light LB1 and the distance D2 from the 0th order light spot 40 to the light condensing position of the second signal light LB2 as the distances of the sides. Thus, the increase in the overall size of the light receiving portion 30 (the area of the light receiving surface 30a) can be effectively suppressed even when in addition to the light receiving elements 33 to 36, the light receiving elements 37a and 37b are provided.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the present invention is applied to the optical disk unit adaptable to the BD in the aforementioned embodiment, the present invention is not restricted to this. The present invention may alternatively be applied to an optical disk unit adaptable to either a DC or a DVD or both the CD and the DVD, other than the BD, or an optical disk unit adaptable to the BD, the CD, and the DVD.

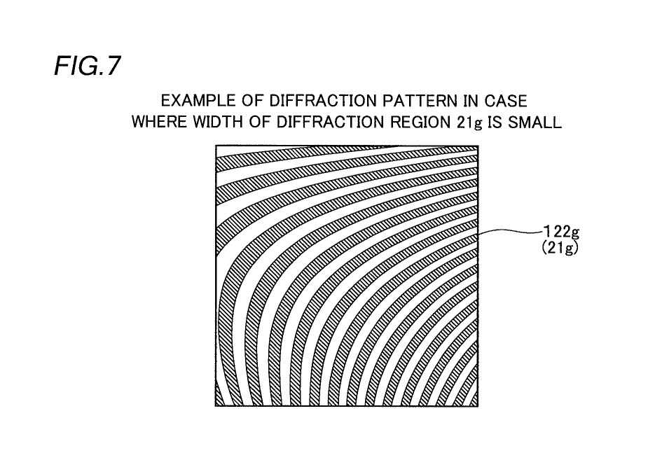

While the diffraction region 21g of the position adjustment light is parallelogram-shaped (see FIG. 3) with the width W1 of the base and the height H1 from the base in the aforementioned embodiment, the present invention is not restricted to this. According to the present invention, either the width of the base or the height from the base or both the width of the base and the height from the base of the diffraction region 21g may alternatively be varied. As described above, the shape of the light condensing spot 45 of the position adjustment light is determined on the basis of a diffraction pattern shape expressed by the phase function Φ and the shape of the diffraction region 21g, and hence even when the width of the diffraction region 21g is reduced, for example, the diffraction pattern is varied according to this, whereby a light condensing spot having a rhombic shape substantially identical to the shape of the light condensing spot 45 can be obtained. When the width of the base of the diffraction region 21g is rendered smaller than the width W1 as an example, the curvature of slits is increased (the degree of curving is increased) as in a diffraction pattern 122g shown in FIG. 7. Also when the height of the diffraction region 21g is varied, the diffraction pattern is varied in the same manner, whereby a light condensing spot having a shape substantially identical to the shape of the light condensing spot 45 can be obtained.

While the diffraction region 21g of the position adjustment light is substantially parallelogram-shaped in the aforementioned embodiment, the present invention is not restricted to this. According to the present invention, the diffraction region of the position adjustment light may alternatively be formed in a shape other than the parallelogram, such as a rectangle, a square, a circle, or an ellipse, for example.

While the light condensing spot 45 of the position adjustment light is formed in the rhombic shape in the aforementioned embodiment, the present invention is not restricted to this. According to the present invention, the light condensing spot of the position adjustment light may alternatively be formed in a shape other than the rhombic shape, such as a parallelogram, a rectangle, a square, a circle, or an ellipse, for example.

While the length L1 (maximum length) in the radial direction R of the light condensing spot 45 of the position adjustment light is larger than the length L2 in the radial direction R of the light receiving elements 37a and 37b in the aforementioned embodiment, the present invention is not restricted to this. According to the present invention, the maximum length in the radial direction of the light condensing spot of the position adjustment light may alternatively be less than or equal to the length in the radial direction of the light receiving elements.

While the width W2 of the light condensing spot 45 is set such that both ends of the light condensing spot 45 in the circumferential direction C are arranged in the vicinity of both ends 37d of the light receiving elements 37a and 37b in the circumferential direction C in the state where the spot center 45a is located on the centerline 37c in the aforementioned embodiment, the present invention is not restricted to this. According to the present invention, both ends of the light condensing spot in the circumferential direction may not be arranged in the vicinity of both ends of the light receiving elements.

While the light condensing spot 45 is formed such that the areas thereof on both sides through the centerline 37c are equal to each other when the spot center 45a is located on the centerline 37c in the aforementioned embodiment, the present invention is not restricted to this. According to the present invention, the areas of the light condensing spot 45 on both sides may not be equal to each other when the spot center 45a is located on the centerline 37c between the light receiving elements 37a and 37b. It is simply required to configure the light splitting element and the light receiving portion such that the light condensing spots of the signal light are arranged in the centers of the light receiving elements at a rotational position where the light receiving area of the light receiving element 37a and the light receiving area of the light receiving element 37b are equal to each other regardless of the position of the spot center. However, the light splitting element is preferably positioned such that the light receiving area of the light receiving element 37a and the light receiving area of the light receiving element 37b are equal to each other in the state where the spot center is located on the centerline, considering the positional displacement of the light condensing spot 45 in the radial direction resulting from positional displacement in the optical axis direction between the light splitting element and the light receiving portion.

While the light condensing spot 45 of the position adjustment light is arranged between the light condensing position (light condensing spots 43 and 44) of the first signal light LB1 and the light condensing position (light condensing spots 41 and 42) of the second signal light LB2 in the circumferential direction C in the aforementioned embodiment, the present invention is not restricted to this. According to the present invention, the light condensing spot of the position adjustment light may alternatively be arranged at a position point-symmetric about the 0th order light spot 40 or at a position line-symmetric about the Y-axis or the X-axis passing through the 0th order light spot 40. in this case, the light, condensing spots of the first signal light and the second signal light and the light condensing spot of the position adjustment light are widely separated from each other, and hence the size of the light receiving portion (the area of the entire light receiving surface) is increased as compared with the structure according to the aforementioned embodiment if the light receiving elements are arranged according to this.

While the light condensing spot 45 of the position adjustment light is formed in such a shape that the length L1 thereof in the radial direction R in the central portion in the circumferential direction C is maximized in the aforementioned embodiment, the present invention is not restricted to this. According to the present invention, the light condensing spot of the position adjustment light may alternatively be formed such that the length thereof in the radial direction at a position other than the central portion in the circumferential direction C is maximized.

While the light splitting element 20 is configured such that the first signal light LB1 is diffracted in the tracking direction (direction Y) to generate the light condensing spots 43 and 44 and the second signal light LB2 is diffracted in the track tangential direction (direction X) to generate the light condensing spots 41 and 42 in the aforementioned embodiment, the present invention is not restricted to this According to the present invention, the first signal light LB1 may alternatively be diffracted in the track tangential direction (direction X), and the second signal light LB2 may alternatively be diffracted in the tracking direction (direction Y). Alternatively, the diffraction directions of the first signal light and the second signal light may be directions other than the direction X and the direction Y.

What is claimed is:

1. An optical pickup comprising:
a light source emitting light to an optical disk;
a light splitting element generating signal light employed for optical disk signal processing and position adjustment light not employed for the optical disk signal processing by splitting return light from the optical disk and dispersing the return light in different directions; and
a light receiving portion having a signal light receiving portion receiving the signal light and an adjustment light receiving portion receiving the position adjustment light, wherein.
the light splitting element is configured such that a position thereof is adjusted on the basis of the position adjustment light received by the adjustment light receiving portion of the light receiving portion.

2. The optical pickup according to claim 1, wherein
the light splitting element is configured to generate first signal light including interfering light formed by a track groove of the optical disk and second signal light not including the interfering light by splitting the signal light and is configured such that a light condensing position of the position adjustment light on a light receiving surface of the light receiving portion is arranged between a light condensing position of the first signal light and a condensing position of the second signal light.

3. The optical pickup according to claim 1, wherein
a light condensing spot of the position adjustment light on a light receiving surface of the light receiving portion has such a shape that both ends of the light condensing spot of the position adjustment light in a circumferential direction about a light condensing position of 0th order light are arranged in a light receiving surface of the adjustment light receiving portion and in the vicinity of both ends of the light receiving surface of the adjustment light receiving portion in the circumferential direction.

4. The optical pickup according to claim 3, wherein
a width in the circumferential direction of the light condensing spot of the position adjustment light is at least about 80% and not more than about 90% of a width in the circumferential direction of the adjustment light receiving portion.

5. The optical pickup according to claim 1, wherein
a light condensing spot of the position adjustment light on a light receiving surface of the light receiving portion has such a shape that a length of the light condensing spot of the position adjustment light in a radial direction about a light condensing position of 0th order light is larger than a length of the adjustment light receiving portion in the radial direction.

6. The optical pickup according to claim 1, wherein
the light splitting element is configured such that a distance from a light condensing position of 0th order light to a light condensing position of the position adjustment light is larger than a distance from the light condensing position of the 0th order light to a light condensing position of the signal light on a light receiving surface of the light receiving portion.

7. The optical pickup according to claim 1, wherein
the adjustment light receiving portion includes a pair of light receiving regions bounded by a centerline extending in a radial direction about a light condensing position of 0th order light, and
a light condensing spot of the position adjustment light on a light receiving surface of the light receiving portion has such a shape that areas of the light condensing spot on both sides through the centerline are equal to each other when a spot center is located on the centerline.

8. The optical pickup according to claim 7, wherein
the light condensing spot of the position adjustment light on the light receiving surface of the light receiving portion has such a shape that both sides of the light condensing spot through the centerline are bilaterally symmetric when the spot center is located on the centerline.

9. The optical pickup according to claim 7, wherein
the light condensing spot of the position adjustment light on the light receiving surface of the light receiving portion has such a shape that a length of the light condensing spot in the radial direction in a central portion in a circumferential direction about the light condensing position of the 0th order light is maximized.

10. The optical pickup according to claim 9, wherein
the light condensing spot of the position adjustment light on the light receiving surface of the light receiving portion has a rhombic shape having a long axis along the radial direction and a short axis along the circumferential direction.

11. The optical pickup according to claim 7, wherein
the light splitting element and the light receiving portion are configured such that a light condensing spot of the signal light is located in a center of the signal light receiving portion when the spot center of the light condensing spot of the position adjustment light on the light receiving surface of the light receiving portion is located on the centerline.

12. The optical pickup according to claim 1, wherein
the light splitting element has a plurality of diffraction gratings splitting the return light into the signal light and the position adjustment light and dispersing the signal light and the position adjustment light In the different directions, and
a diffraction grating for the position adjustment light of the diffraction gratings is arranged in a central portion of a region of the light splitting element through which the return light from the optical disk penetrates.

13. The optical pickup according to claim 12, wherein
the light splitting element includes a hologram element formed with a plurality of diffraction patterns constituting the plurality of diffraction gratings.

14. The optical pickup according to claim 12, wherein
a plurality of diffraction gratings for the signal light of the diffraction gratings are provided to surround the diffraction grating for the position adjustment light arranged in the central portion of the region of the light splitting element through which the return light penetrates.

15. The optical pickup according to claim 2, wherein the light splitting element is configured to diffract the position adjustment light toward a position in a direction dividing an angle between a diffraction direction of the first signal light from a light condensing position of 0th order light to the light condensing position of the first signal light and a diffraction direction of the second signal light from the light condensing position of the 0th order light to the light condensing position of the second signal light substantially equally on the light receiving surface of the light receiving portion.

16. The optical pickup according to claim 2, wherein
the light splitting element is configured such that the light condensing position of the position adjustment light falls within a rectangular region using a distance from a light condensing position of 0th order light to the light condensing position of the first signal light and a distance from the light condensing position of the 0th order light to the light condensing position of the second signal light as distances of sides on the light receiving surface of the light receiving portion.

17. An optical disk unit comprising:
an optical pickup emitting light to an optical disk and detecting return light from the optical disk; and
a control portion performing reproduction control for the optical disk on the basis of an output signal of the optical pickup, wherein
the optical pickup includes:
a light, source emitting the light to the optical disk,
a light splitting element generating signal light employed for optical disk signal processing and position adjustment light not employed for the optical disk signal processing by splitting the return light from the optical disk and dispersing the return light in different directions, and
a light receiving portion having a signal light receiving portion receiving the signal light and an adjustment light receiving portion receiving the position adjustment light, and
the light splitting element is configured such that a position thereof is adjusted on the basis of the position adjustment light received by the adjustment light receiving portion of the light receiving portion.

18. The optical disk unit according to claim 17, wherein
the light splitting element is configured to generate first signal light including interfering light formed by a track groove of the optical disk and second signal light not including the interfering light by splitting the signal light and is configured such that a light condensing position of the position adjustment light on a light receiving surface of the light receiving portion is arranged between a light condensing position of the first signal light and a light condensing position of the second signal light.

19. The optical disk unit according to claim 17, wherein
a light condensing spot of the position adjustment light on a light receiving surface of the light receiving portion has such a shape that both ends of the light condensing spot of the position adjustment light in a circumferential direction about a light condensing position of 0th order light are arranged in as light receiving surface of the adjustment light receiving portion and in the vicinity of both ends of the light receiving surface of the adjustment light receiving portion in the circumferential direction.

20. The optical disk unit according to claim 17, wherein
the adjustment light receiving portion includes a pair of light receiving regions bounded by a centerline extending in a radial direction about a light condensing position of 0th order light, and
a light condensing spot of the position adjustment light on a light receiving surface of the light receiving portion has such a shape that areas of the light condensing spot on both sides through the centerline are equal to each other when a spot center is located on the centerline.
